(19) United States
(12) Patent Application Publication
(10) Pub. No.: US 2009/0171902 A1
(43) Pub. Date: Jul. 2, 2009

(54) LIFE RECORDER

(75) Inventors: Matthew B. MacLaurin, Woodinville, WA (US); William T. Flora, Seattle, WA (US); Steven N. Bathiche, Kirkland, WA (US); Boyd Cannon Multerer, Redmond, WA (US); John Mark Miller, Kirkland, WA (US); Bret P. O'Rourke, Kirkland, WA (US)

Correspondence Address: TUROCY & WATSON, LLP, 127 Public Square, 57th Floor, Key Tower, CLEVELAND, OH, 44114, US

(73) Assignee: MICROSOFT CORPORATION, Redmond, WA (US)

(21) Appl. No.: 11/966,921

(22) Filed: Dec. 28, 2007

(51) Int. Cl. G06F 17/10; G06F 17/30

(52) U.S. Cl. 707/3; 707/104.1; 707/E17.009

(57) ABSTRACT

A system that can automatically capture life experiences of a user across a number of senses or perceptions is provided. Once the data is captured, it can be annotated and saved for subsequent playback. The innovation also enables the data to be synchronized to for playback, for example, audio can be time-synced to a corresponding video with a corresponding smell, etc. Still further, the innovation provides for controls that enable a user to adjust or select granularity for capture as well as playback.

### BACKGROUND

It is not uncommon for individuals to take photographs to create a lasting memory of an event. For example, photographs captured during a vacation can be viewed to reminisce about a time away in an exotic location, a visit with friends, etc. These images can be shared with friends to visually tell a story of an event that may have occurred during the vacation, for example.

Recent developments have been directed to optical systems that can be worn around a user's neck to capture a sequence of still images related to events of an individual. However, conventional systems have been limited to the capture of still or visual images. In other words, these emerging systems are merely optical devices that can be manually triggered or alternatively triggered by changes in factors such as lighting, temperature or movement. For instance, if a user wears one of these traditional devices, upon leaving (or entering) a building, the system can detect a change in ambient lighting and thereby prompt the capture of a series of images. These images can later be used to visually recreate a user's experience.

For example, a user can review images days, weeks, or months later to determine a brand of wine they shared with a friend at dinner. Or, in another example, a loved one can review the images to determine activities completed by the elderly. Essentially, still images of traditional systems can be reviewed by the wearer, a loved one or even a health care professional to recall, share, or analyze activities of a wearer.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a system that can capture life experiences of a user across a number of senses or perceptions. Once the data is captured, it can be annotated and saved for subsequent playback. Additionally, the specification enables the data to be synchronized for playback, for example, audio can be time-synced to a corresponding video, etc. Still further, the specification provides for controls that enable a user to adjust or select granularity for data capture as well as playback.

The ability to capture life-related events enables replay to better and more fully comprehend the event. Essentially, the innovation facilitates a ‘replay’ similar to those often employed in viewing of a sporting event via television (e.g., ‘instant replay’). In other words, if a user would like to ‘re-live’, share or otherwise view a past event, the innovation makes this possible. Particularly, the innovation can enable the event to be replayed by synchronizing data captured across a number of perspectives or senses.

In aspects, the innovation provides adjustments and controls that allow different granularities to be preserved if desired. For instance, events within the past few hours can be saved at high granularity while events that occurred further back in time can be viewed at coarser granularities if desired. For example, yesterday's events may be viewed one frame at a time at 30 second intervals where today's events can be viewed in real time. These granularities can be automatically set, preset or inferred on-the-fly based upon factors such as context, content, etc.

The information can be stored in most any format. Additionally, the captured information can be retrieved based upon a query or other search request. Stored memories can be employed for life modeling and can be used in such aspects as location gaming, changing or altering one's perception based on the past experiences, utilizing augmented realities based on the recorded experiences, and even substituting alternative realities, if desired.

In yet another aspect thereof, machine learning and reasoning component is provided that employs a probabilistic and/or statistical-based analysis to prognose or infer an action that a user desires to be automatically performed.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates a system that facilitates life recording in accordance with aspects of the innovation.

FIG. 2 illustrates an example flow chart of procedures that facilitate capturing, annotating and storing life-event related in accordance with an aspect of the innovation.

FIG. 3 illustrates an example flow chart of procedures that facilitate searching, synchronizing and rendering captured data in accordance with aspects of the innovation.

FIG. 4 illustrates an example block diagram of an experience monitor component in accordance with an aspect of the innovation.

FIG. 5 illustrates an example block diagram of an experience monitor component that employs physiological and environmental sensing mechanisms in accordance with aspects of the innovation.

FIG. 6 illustrates sample contextual data that can be used in accordance with aspects of the specification to trigger, annotate or render event-related data.

FIG. 7 illustrates an example experience capture component the employs analysis and recorder components to effect data capture in accordance with aspects.

FIG. 8 illustrates an example block diagram of a rendering component that facilitates rendering captured data to a user.

FIG. 9 illustrates an example block diagram of a content configuration component that enables synchronization as well as user interface in accordance with aspects.

FIG. 10 illustrates an architecture including an artificial intelligence-based component that can automate functionality in accordance with an aspect of the novel innovation.

FIG. 11 illustrates a block diagram of a computer operable to execute the disclosed architecture.

FIG. 12 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

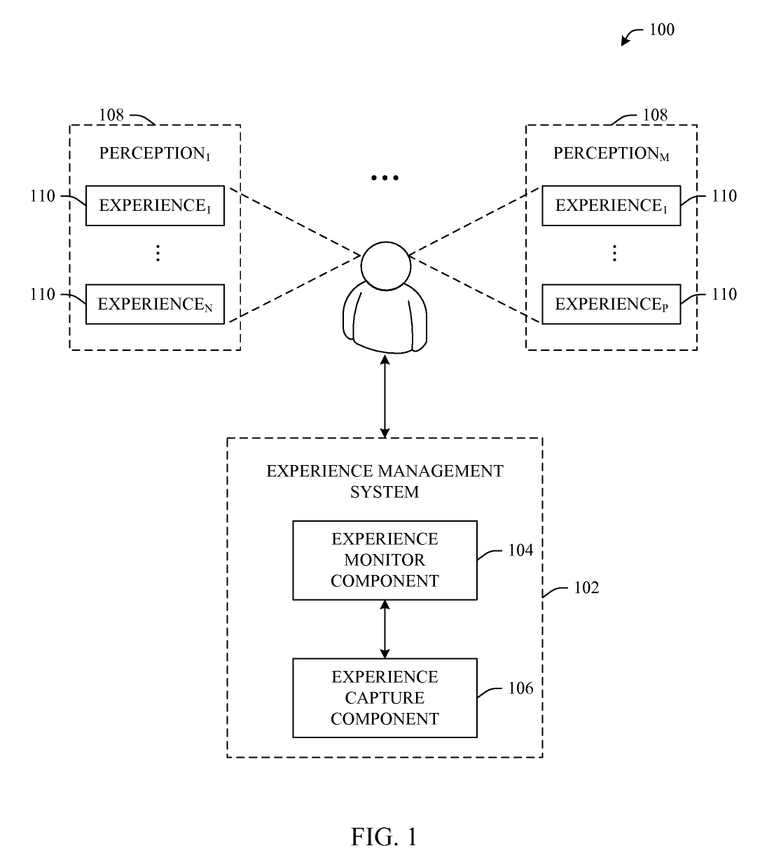

Referring initially to the drawings, FIG. 1 illustrates a block diagram of an example system 100 that enables life events and experiences to be monitored and captured based upon context. As will be described in greater detail infra, these experiences can be captured in accordance with most any available perception type. For example, visual data, audible data, scent data, etc. can be captured as related to a real-world experience. These data elements can be annotated and/or tagged and thereafter queried or otherwise retrieved for playback.

As will be further described, prior to playback, the perception data can be synchronized so as to create a rich presentation experience to a user. For instance, visual data can be synchronized to audible data and thereafter configured for rendering on a particular device. The granularity of the presentation can be manually selected by a user or automatically selected based upon factors such as, device type, content, context, or other desired factors.

Oftentimes events occur where it would be desirable to have the ability to replay the event within a short period in order to better and more fully comprehend the event. In other words, by replaying the event, oftentimes an individual can ‘relive,’ enjoy or learn from a past experience. Still further, events can be shared with other individuals to share experiences, learn from other's experiences or even see or experience an event or location from another's perspective.

Unfortunately, events happen in real time and people are not given the opportunity to relive the event after it has occurred. Not only are the events hard to relive, but they also occur over multiple dimensions (or perceptions) and human senses. Thus, not only does one see what is going on but also hear and feel the event, for example.

FIG. 1 illustrates a system 100 that can capture these life experiences thereby enabling playback or retention for later use as desired. Essentially, the innovation can be viewed as a ‘life recorder’ that is imbued with tremendous memory capability and is always running, similar to a wristwatch. As will be described, the recorder can record over multiple senses such that people can replay events so they can better appreciate things that may have occurred, learn, share, reminisce, etc.

Generally, system 100 can include an experience management system 102 having an experience monitor component 104 and an experience capture component 106. Together, these sub-components (104, 106) monitor perceptions 1 to M and capture 1 to N and 1 to P experiences respectively, where M, N and P are integers. In operation, the experience management component 102 can monitor (e.g., via experience monitor component 104) experiences 110 as perceived by perceptions 108. Thereafter, the experience capture component 106 can facilitate capture and/or storage of data associated with the experiences. It is to be understood that the data can be stored locally, remotely (e.g., server-based, remote storage, Internet, cloud-based) or distributed in a system that includes a combination of local and remote storage.

The experience monitor component 104 can include or employ sensory mechanisms to monitor experiences 110 that occur. For instance, sensors can be employed to capture contextual factors such as current weather conditions, locations, mood, state of mind, etc. These factors can be used to trigger the capture of the information, enhance description of captured information, and to annotate captured information.

The experience capture component 106 can include adjustments and controls that allow different granularities of information to be preserved (or subsequently presented) if desired. For instance, events or experiences within the past few hours can be saved at high granularity where events that occurred further back in time can be viewed at coarser granularities, if desired. For example, yesterday's events may be viewed one frame at a time at 30 second intervals where today's events can be viewed in real time. Similarly, different perceptions 108 (e.g., senses) can be captured at different granularities as desired.

In one embodiment, the captured information can be used to facilitate and otherwise enhance reputation systems in order to provide a richer user experience. For instance, media agents can be employed to search and find desired media content related to a given profile. This media content can refer, in part, to the information captured by the experience monitor system 102.

Other aspects of the innovation include the ability to access information to better understand opinions on a given subject. For instance, this captured information can describe what someone else thinks about a particular topic or what type of experience others had upon visiting a particular location. It will be understood that the example uses and benefits of the captured information are countless. Accordingly, examples provided herein are included merely to add perspective to the innovation and are not intended to limit the innovation in any way.

In other aspects, ideas can be generated based upon social contexts such as pushing information related to a person in an upcoming meeting. Social suggestions can be made based upon of the profiles where profiles can be automatically annotated with experiences such as the recorded life experiences over time. From past experiences, interests can be discovered and possible new interests can be mined over time. Stored memories can be employed for life modeling to be used in such aspects as location gaming, changing or altering one's perception based on the past experiences, utilizing augmented realities based on the recorded experiences, and even substituting alternative realities, if desired. It will be understood the security and access control lists can be employed to address privacy concerns related to capture and access to experience information. In other words, a user can grant or deny access to capture and/or share information as desired.

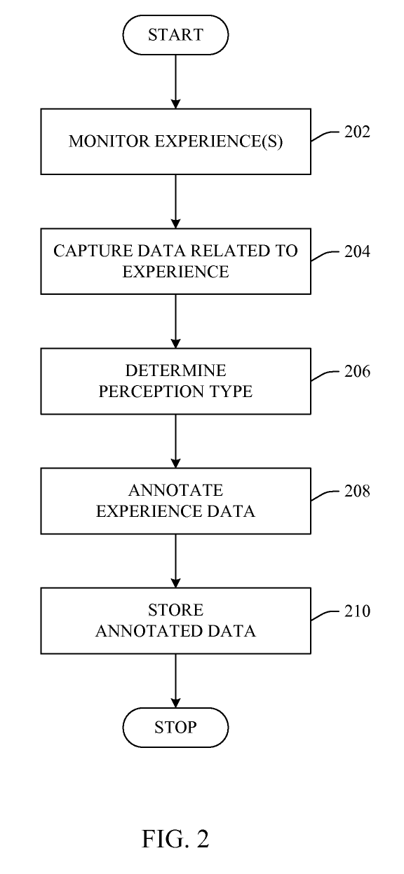

FIG. 2 illustrates an example methodology of monitoring experience data in accordance with an aspect of the innovation. As described with reference to FIG. 1, the innovation monitors, tracks and captures data related to real-life experiences of a user. The data and information can be tracked or monitored by way of sensory mechanisms and thereafter captured in accordance with a predetermined or inferred preference or policy. Similarly, these sensory mechanisms can be employed to monitor contextual factors which can essentially be used to trigger capture of information. These and other aspects will become more apparent upon a review of the figures and examples that follow.

While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 202, experiences are monitored, for example, day-to-day real-life events and experiences of a user are monitored or tracked. Essentially, the innovation enables an electronic journal of user experiences to be captured and stored. This electronic journal can be search, queried, shared, replayed, etc. Features, functions and benefits of the innovation will be understood and appreciated upon a review of the figures that follow.

At 204, data related to an experience is captured. For example, visual (e.g., video, still images), audio (e.g., spoken words, auditory sounds), smells, feelings (e.g., temperature, textures) data can be captured. Additionally, contextual factors related to the user physiological state, environment, etc. can also be captured. The perception type(s) employed for the capture can be determined at 206. Here, a determination can be made if the data was captured by a sense of sight, hearing, smell, or feeling.

At 208, the captured data can be annotated with metadata or other tags which describe the data. It is to be understood that this metadata facilitates subsequent location for presentation. For instance, the perception type, content of experience, context related to experience or other such descriptive metadata can be annotated to the data. Finally, at 210, the data can be stored in a local or remote storage facility.

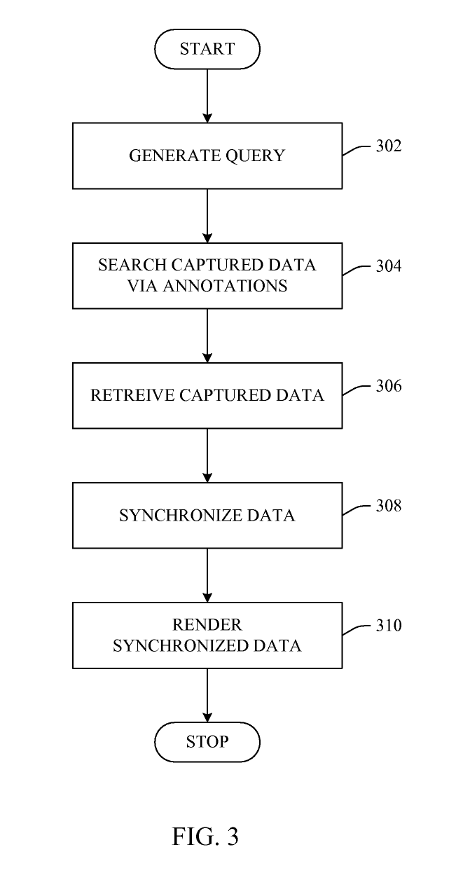

Referring now to FIG. 3, there is illustrated an example methodology of retrieving and employing the electronic journal in accordance with the innovation. At 302, a query or other search criteria is generated. It is to be appreciated that, in aspects, a query can be explicitly generated by a user. For example, suppose a user is preparing to engage in troubleshooting a certain type of wireless network router in their home. Here, the user can explicitly establish a query with keywords such as, ‘troubleshoot a brand X wireless network router.’ In other examples, the system can automatically determine or infer the user's action or desire. Subsequently, a query can be automatically generated and/or inferred on behalf of the user. It will be understood that the example features, functions and benefits of the innovation are countless. Accordingly, this specification is to include all feasible aspects within the scope of this disclosure and claims appended hereto. For instance, in a more simplistic example, a user might be interested in baking a cake, or even changing an infant's diaper. These are just two more examples of how the features, functions and/or benefits of the innovation can be employed.

At 304, the annotations attached to captured data can be searched based upon a search query. It will be understood that the innovation contemplates security and access control lists to address privacy concerns associated with monitoring actions of individuals. For brevity, the examples do not discuss these concerns however, it is to be understood that they are to be considered within the scope of this specification and claims appended hereto.

Accordingly, data can be retrieved at 306. Once data is retrieved, it can be synchronized at 308 and rendered at 310. In other words, at 308, audio can be matched to video, etc. Thereafter, the synchronized data can be rendered at 310.

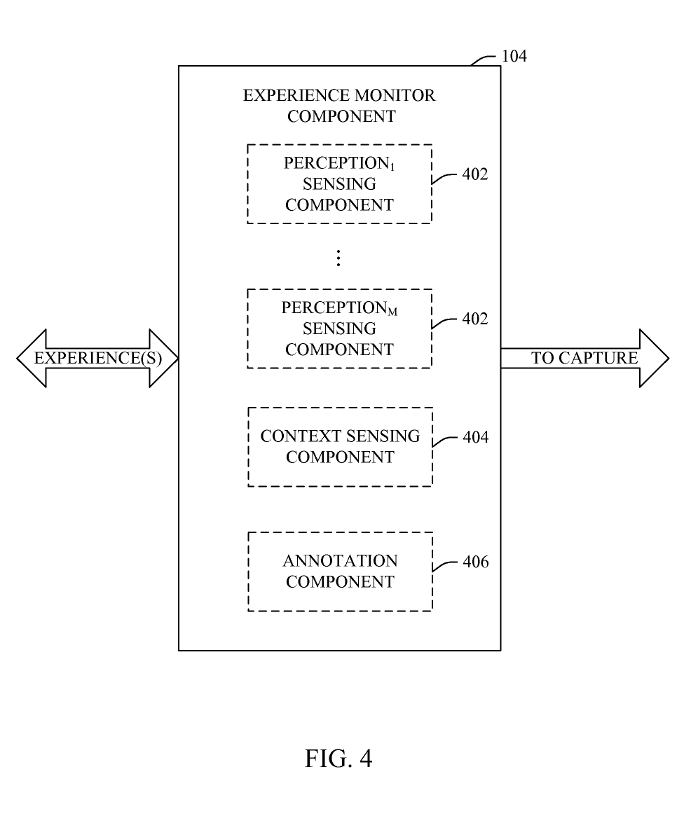

Turning now to FIG. 4, an example block diagram of an experience monitor component 104 in accordance with an aspect of the innovation is shown. Generally, the component 104 includes 1 to M perception sensing components 402, where M is an integer. Additionally, the experience monitor component 104 includes a context sensing component 404 and an annotation component 406. Together, these components (402, 404, 406) enable experience data to be captured and annotated (or otherwise tagged) for indexing and storage.

The perception sensing component(s) 402 can include sensory mechanisms that capture data related to the experiences of a user. For example, the perception sensing component 402 can capture visual data, auditory data, etc. related to an experience. In other words, individual data streams can be captured that represent individual sensory data. In other aspects, multi-perception data can be collected, annotated and stored as desired.

The context sensing component 404 can enable capture of situational data that relates or is associated to the actual experience data. For example, situational data can include subject user location, time of day, weather, physiological data, activity data, demographics, as well as most any other detectable descriptive data. As will be described below, the contextual data can include environmental as well as physiological data as appropriate.

The annotation component 406 can be employed to attach, embed or otherwise associate descriptive metadata or tagging data to the captured experience. This annotation data can be used to index and later search the stored data. The annotation data can essentially be used to explicitly or implicitly retrieve data for replay, presentation or other useful rendering.

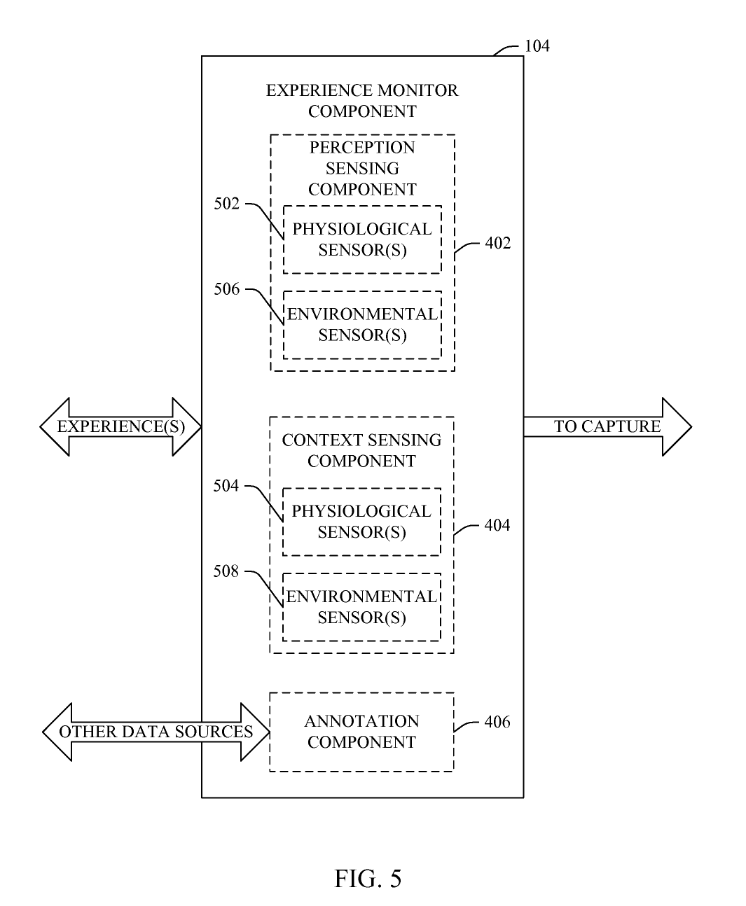

Referring now to FIG. 5, an alternative block diagram of an example experience monitor component 104 is shown. Essentially, FIG. 5 illustrates that both the perception sensing component and the context sensing component can include physiological (502, 504) and/or environmental (506, 508) sensors. Still further, as shown, the annotation component 406 is capable to obtain other data which can be employed to further describe the captured experience data.

The following example is provided merely to add perspective to the innovation and is not intended to limit the scope of this specification in any manner. Rather, the following example is included to illustrate features, functions and benefits of the innovation by describing a real-world application. It is to be understood that other examples exist and are to be included within the spirit and/or scope of the innovation and claims appended hereto.

In an example scenario, experiences during an individual's hiking trip can be captured. During a hike, the perception sensing component 402 can capture visual data related to sights experienced during the hike. Similarly, auditory data can be captured. Other data can be processed by the annotation component 406 which can be used to annotate the captured experience. For example, the Internet can be accessed to determine the length of the hike, elevation, terrain, etc. It will be appreciated, that some, if not all, of these factors can also be captured by the environmental sensors 508.

In aspects, sensors 502, 504, 506 and 508 can be direct indicating sensors. Direct-indicating sensors, for example, a mercury thermometer, are human-readable. Other sensors, such as a thermocouple, can produce an output voltage or other electrical output which can be interpreted by another device (such as a computer processor or software application).

It will be appreciated that sensors are used in everyday applications, such as touch-sensitive elevator buttons, automobile locking mechanisms, biometric fingerprint readers, etc. This information can be captured by the experience monitor component 104. A sensor's sensitivity indicates how much the sensor's output changes when the measured quantity changes. For instance, if the mercury in a thermometer moves 1 cm when the temperature changes by 1°, the sensitivity is 1 cm/1°. Sensors that measure very small changes have very high sensitivities. Technological progress allows more and more sensors to be manufactured on a microscopic scale as ‘microsensors’ that use MEMS (microelectromechanical systems) technology. It is to be understood and appreciated that, although the example experience monitor component of FIG. 5 includes physiological sensors 502, 504 and environmental sensors 505, 508, most any sensory mechanisms can be employed in accordance with the innovation.

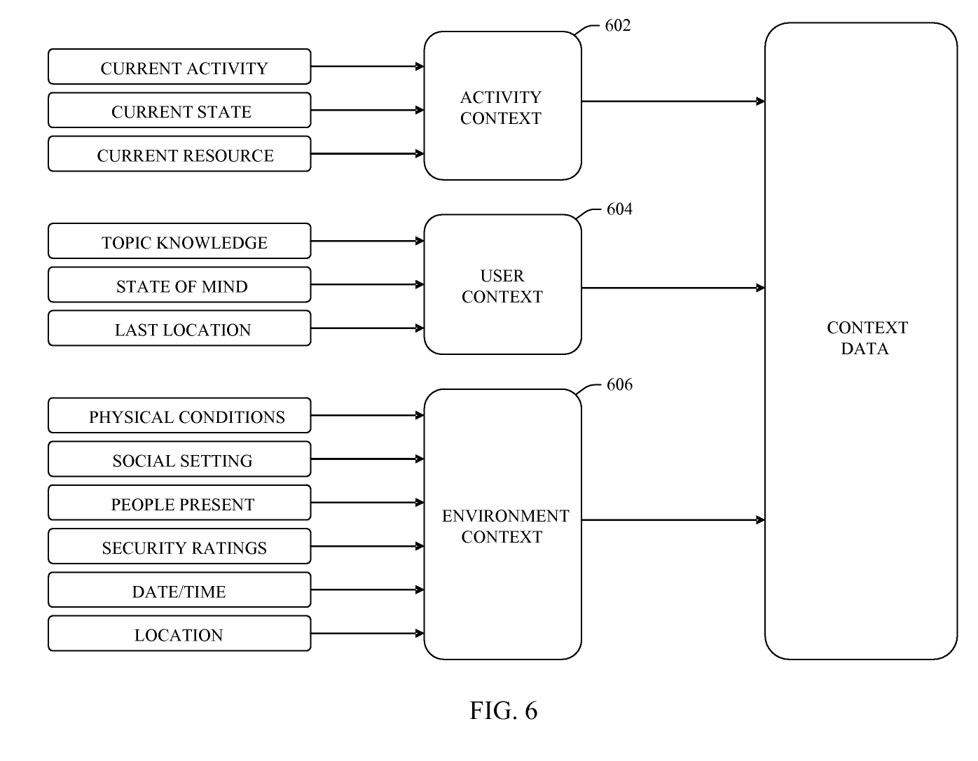

FIG. 6 illustrates a sampling of the kinds of data that can be gathered by the context sensing component, 404 of FIG. 4. In accordance with the aspect illustrated in FIG. 6, the activity context data can be divided into 3 classes: activity context 602, user context 604, and environment context 606.

By way of example, and not limitation, the activity context data 602 includes the current activity the user is performing. It is to be understood that this activity information can be explicitly determined and/or inferred. Additionally, the activity context data 602 can include the current step (if any) within the activity. In other words, the current step can be described as the current state of the activity. Moreover, the activity context data 602 can include a current resource (e.g., file, application, gadget, email, etc.) that the user is interacting with in accordance with the activity.

In an aspect, the user context data 604 can include topics of knowledge that the user knows about with respect to the activity and/or application. As well, the user context data 604 can include an estimate of the user's state of mind (e.g., happy, frustrated, confused, angry, etc.). It will be understood and appreciated that the user's state of mind can be estimated using different input modalities, for example, the user can express intent and feelings, the system can analyze pressure and movement on a mouse, content and/or intensity of verbal statements, physiological signals, etc. to determine state of mind.

With continued reference to FIG. 6, the environment context data 606 can include the physical conditions of the environment (e.g., wind, lighting, ambient, sound, temperature, etc.), the social setting (e.g., user is in a business meeting, or user is having dinner with his family), the other people who are in the user's immediate vicinity, data about how secure the location/system/network are, the date and time, and the location of the user. As stated above, although specific data is identified in FIG. 6, it is to be understood that additional types of data can be gathered and employed in annotating captured data in accordance with an aspect of the innovation. As well, it is to be understood that this additional data is to be included within the scope of the disclosure and claims appended hereto.

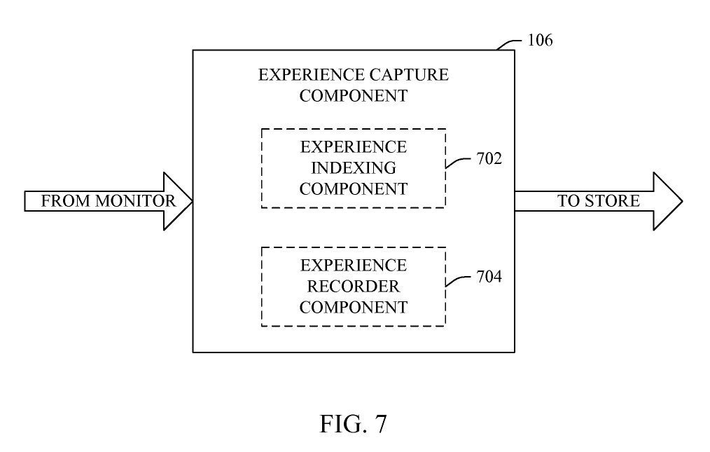

Turning now to FIG. 7, a block diagram of an example experience capture component 104 is shown. As illustrated, the experience capture component 106 can include an experience indexing component 702 and an experience recording component 704. In operation, each of these sub-components 702, 704 enable index and storage of annotated experience data respectively.

The experience indexing component 702 can establish an index based upon annotations provided by the annotation component (406 of FIG. 4). It is to be understood that most any indexing technique can be employed in aspects of the innovation. In one example, the index can be based upon keywords derived from an analysis of the experience alone or in addition to with the contextual data.

Continuing with the aforementioned hiking example, the index can be established based upon words that describe a hike, trek, climb or the like. As well, the experience data can be indexed based upon the location of the hike as well as other contextual data. Most any descriptive data (e.g., keywords, maps, image data) can be used to index experience data.

The experience recorder component 704 can be used to store or otherwise maintain the experience data for subsequent access. As described above, the experience data can be maintained locally, remotely or distributed as desired. Essentially, once the data is indexed and stored, it can later be restored or replayed for most any desired reason, including but not limited to, replay, sharing, learning, researching, medical reasons, therapy, or the like.

Additionally, the experience recorder component 704 can enable explicit or implicit granularity adjustment of experience data. For example, a user can explicitly adjust the granularity of captured data based upon data type, time of day, location, content, context or other desired factor(s). Similarly, the component 704 can automatically adjust the granularity based upon most any factor including but, not limited to type, content, context or the like.

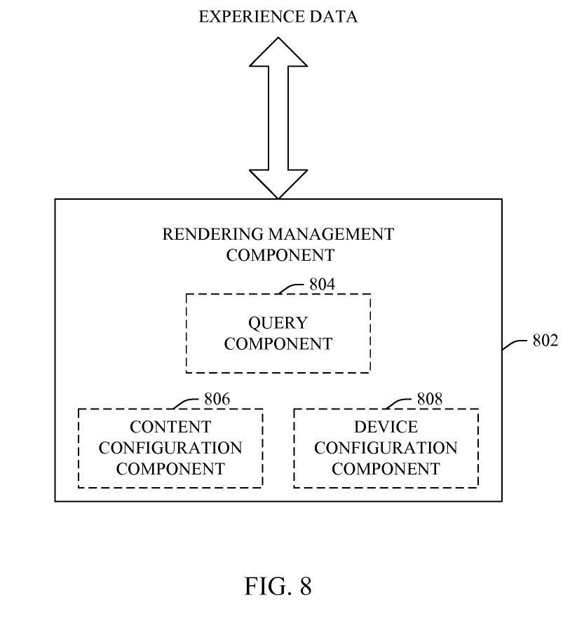

Referring now to FIG. 8, an example rendering management component 802 is shown in accordance with an aspect of the innovation. Essentially, the rendering management component 802 enables users to retrieve, access, share or otherwise obtain previously stored experience data. Although not illustrated, it is to be appreciated that the rendering component can include or employ machine learning and reasoning (MLR) mechanisms. For example, the query generation component 804 can employ MLR mechanisms to automatically generate and/or configure queries on behalf of a user (e.g., based upon context).

As illustrated, the rendering management component 802 can include a query component 804, a content configuration component 806 and a device configuration component 808. Each of these sub-components enable previously stored experience data to be accessed by or presented to a user (or application).

The query component 804 enables a user to explicitly generate a query. For example, if a user wants to re-live an experience, a query can be established to locate the saved data. Similarly, a query can be established to locate saved experience data that relates to other's experiences, for example, to troubleshoot a wireless router. Still further, queries can be dynamically inferred or generated using MLR mechanisms based upon historical, statistical and/or contextual data. Once a query (or other suitable search) is established, the query component 804 can locate, access, retrieve or otherwise obtain relevant experience data.

The content configuration component 806 can be employed to prepare the experience data for delivery or presentation. Similarly, the device configuration component 808 can be employed to arrange or configure the experience data based upon capabilities associated with the target rendering device. For instance, if the target rendering device is a smart-phone or personal digital assistant (PDA), the device configuration component 808 can configure the data differently than it would for a desktop computer based upon processing power, memory, display size/characteristics, etc.

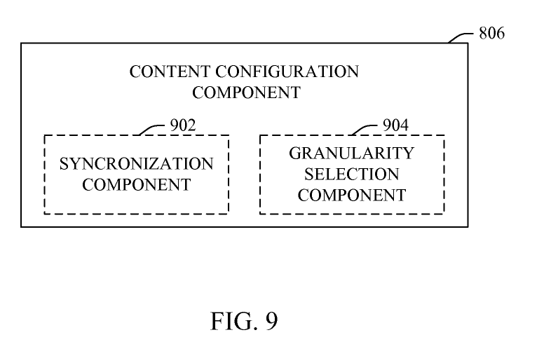

Turning now to FIG. 9, an example block diagram of a content configuration component 806 is shown. Generally, the component 806 includes a synchronization component 902 and a granularity selection component 904. In operation, these sub-components 902, 904 enable preparation of the experience data for rendering.

The synchronization component 902 can enable synchronization of multi-perception data for rendering. For example, where visual and audible data is captured, the synchronization data can combine the data such that a multi-perception data stream can be rendered. As described above, the annotations can be employed to effect synchronization in aspects.

The granularity selection component 904 enables presentation, playback or rendering granularity to be dynamically, explicitly or implicitly selected. In one aspect, a user can automatically select the granularity for playback. In other aspects, the granularity can be selected on behalf of a user, for example, based upon target device capabilities.

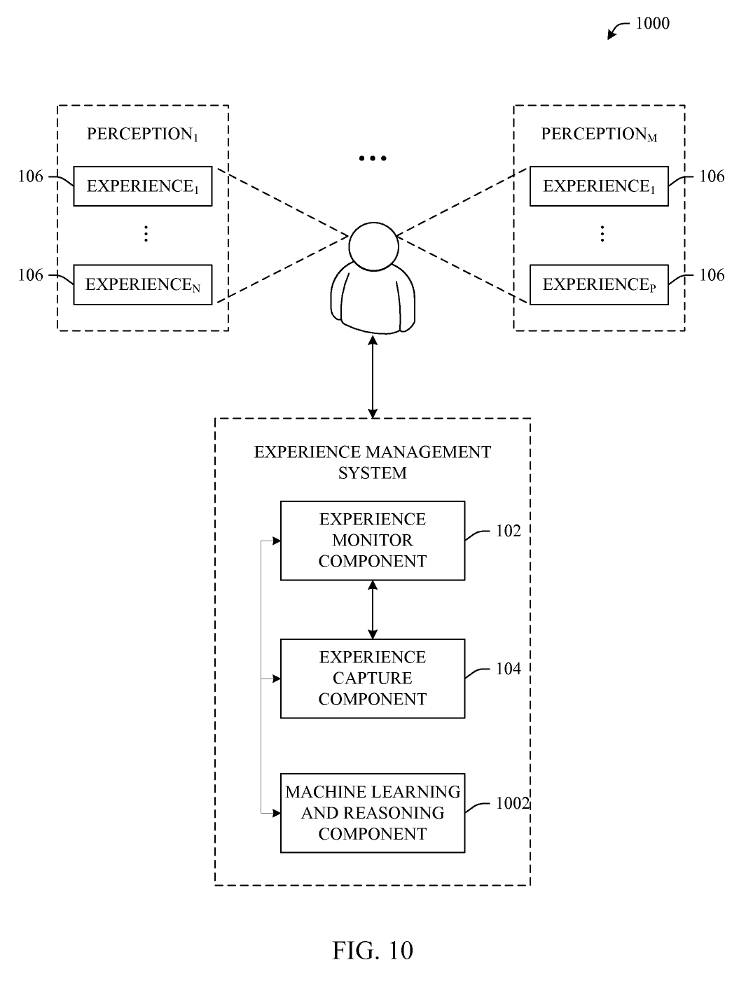

FIG. 10 illustrates a system 1000 that employs an MLR component 1002 which facilitates automating one or more features in accordance with the subject innovation. The subject innovation (e.g., in connection with content selection) can employ various MLR-based schemes for carrying out various aspects thereof. For example, a process for determining what content to capture, how to annotate, what granularity to employ, etc. can be facilitated via an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria when to capture experience data, what experience data to capture, which perception(s) to employ, how to annotate the captured data, what granularity to employ for capture, what granularity to employ for rendering, how to configure data for rendering, etc.

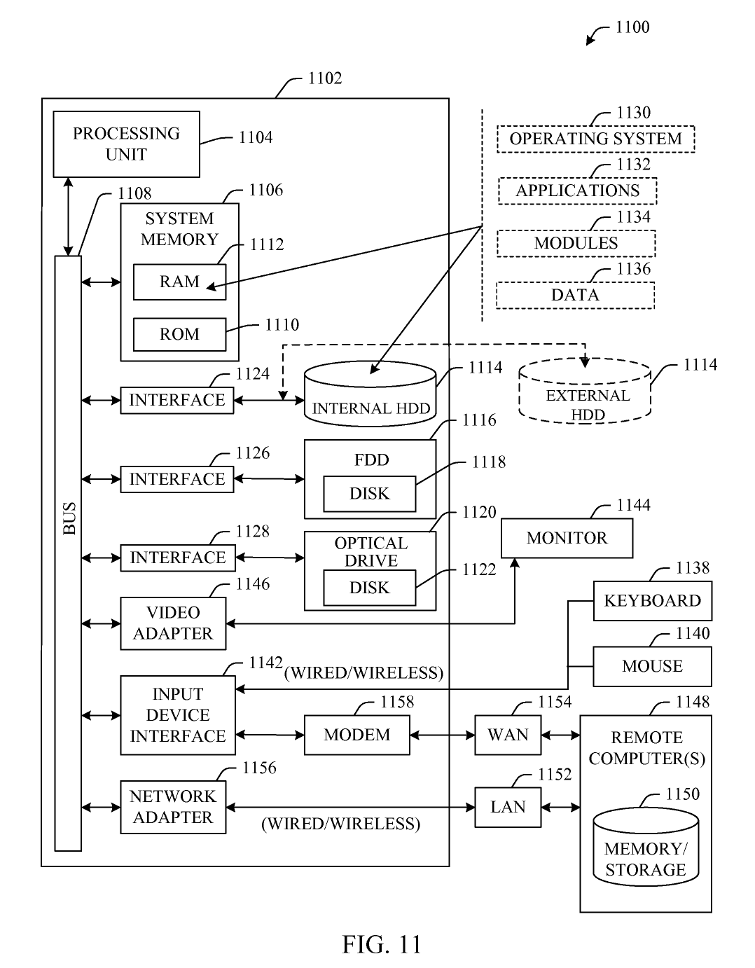

Referring now to FIG. 11, there is illustrated a block diagram of a computer operable to execute the disclosed architecture. In order to provide additional context for various aspects of the subject innovation, FIG. 11 and the following discussion are intended to provide a brief, general description of a suitable computing environment 1100 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 11, the exemplary environment 1100 for implementing various aspects of the innovation includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures may also be employed as the processing unit 1104.

The system bus 1108 can be any of several types of bus structure that may further interconnect to a memory bus (with or without a memory controller), a peripheral bus, and a local bus using any of a variety of commercially available bus architectures. The system memory 1106 includes read-only memory (ROM) 1110 and random access memory (RAM) 1112. A basic input/output system (BIOS) is stored in a non-volatile memory 1110 such as ROM, EPROM, EEPROM, which BIOS contains the basic routines that help to transfer information between elements within the computer 1102, such as during start-up. The RAM 1112 can also include a high-speed RAM such as static RAM for caching data.

The computer 1102 further includes an internal hard disk drive (HDD) 1114 (e.g., EIDE, SATA), which internal hard disk drive 1114 may also be configured for external use in a suitable chassis (not shown), a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as the DVD). The hard disk drive 1114, magnetic disk drive 1116 and optical disk drive 1120 can be connected to the system bus 1108 by a hard disk drive interface 1124, a magnetic disk drive interface 1126 and an optical drive interface 1128, respectively. The interface 1124 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1102, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. It is appreciated that the innovation can be implemented with various commercially available operating systems or combinations of operating systems.

A user can enter commands and information into the computer 1102 through one or more wired/wireless input devices, e.g., a keyboard 1138 and a pointing device, such as a mouse 1140. Other input devices (not shown) may include a microphone, an IR remote control, a joystick, a game pad, a stylus pen, touch screen, or the like. These and other input devices are often connected to the processing unit 1104 through an input device interface 1142 that is coupled to the system bus 1108, but can be connected by other interfaces, such as a parallel port, an IEEE 1394 serial port, a game port, a USB port, an IR interface, etc.

A monitor 1144 or other type of display device is also connected to the system bus 1108 via an interface, such as a video adapter 1146. In addition to the monitor 1144, a computer typically includes other peripheral output devices (not shown), such as speakers, printers, etc.

The computer 1102 may operate in a networked environment using logical connections via wired and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wired/wireless connectivity to a local area network (LAN) 1152 and/or larger networks, e.g. a wide area network (WAN) 1154. Such LAN and WAN networking environments are commonplace in offices and companies, and facilitate enterprise-wide computer networks, such as intranets, all of which may connect to a global communications network, e.g., the Internet.

When used in a LAN networking environment, the computer 1102 is connected to the local network 1152 through a wired and/or wireless communication network interface or adapter 1156. The adapter 1156 may facilitate wired or wireless communication to the LAN 1152, which may also include a wireless access point disposed thereon for communicating with the wireless adapter 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wired or wireless device, is connected to the system bus 1108 via the serial port interface 1142. In a networked environment, program modules depicted relative to the computer 1102, or portions thereof, can be stored in the remote memory/storage device 1150. It will be appreciated that the network connections shown are exemplary and other means of establishing a communications link between the computers can be used.

The computer 1102 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10 BaseT wired Ethernet networks used in many offices.

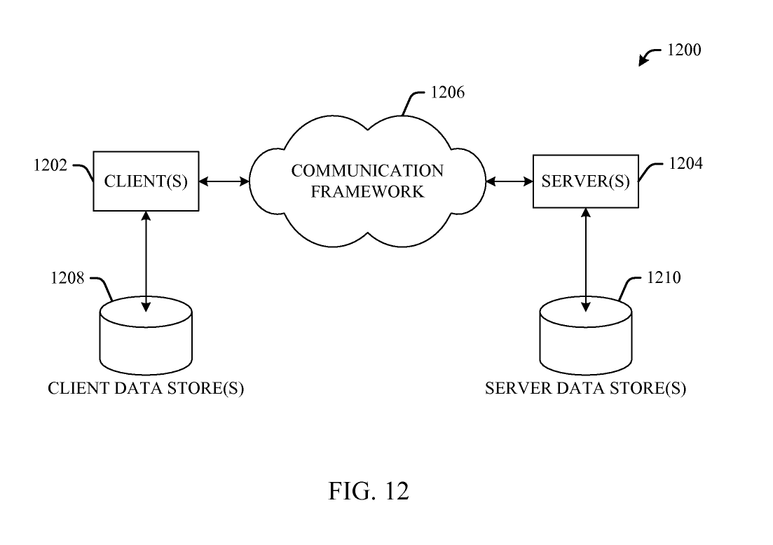

Referring now to FIG. 12, there is illustrated a schematic block diagram of an exemplary computing environment 1200 in accordance with the subject innovation. The system 1200 includes one or more client(s) 1202. The client(s) 1202 can be hardware and/or software (e.g., threads, processes, computing devices). The client(s) 1202 can house cookie(s) and/or associated contextual information by employing the innovation, for example.

The system 1200 also includes one or more server(s) 1204. The server(s) 1204 can also be hardware and/or software (e.g., threads, processes, computing devices). The servers 1204 can house threads to perform transformations by employing the innovation, for example. One possible communication between a client 1202 and a server 1204 can be in the form of a data packet adapted to be transmitted between two or more computer processes. The data packet may include a cookie and/or associated contextual information, for example. The system 1200 includes a communication framework 1206 (e.g., a global communication network such as the Internet) that can be employed to facilitate communications between the client(s) 1202 and the server(s) 1204.

Communications can be facilitated via a wired (including optical fiber) and/or wireless technology. The client(s) 1202 are operatively connected to one or more client data store(s) 1208 that can be employed to store information local to the client(s) 1202 (e.g., cookie(s) and/or associated contextual information). Similarly, the server(s) 1204 are operatively connected to one or more server data store(s) 1210 that can be employed to store information local to the servers 1204.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates recreation of an experience, comprising:
an experience monitor component that observes a plurality of experiences in view of context; and
an experience capture component that employs at least two perceptions to obtain data associated with a subset of the plurality of experiences.

2. The system of claim 1, the plurality of perceptions includes at least two of vision, hearing, touch, smell, or taste.

3. The system of claim 1, further comprising a plurality of perception sensing components that facilitate data capture associated with a corresponding perception.

4. The system of claim 3, each of the perception sensing components includes at least one of a physiological or environmental sensor component.

5. The system of claim 1, further comprising a context sensing component that establishes the context based upon activity context, user context or device context.

6. The system of claim 1, the context sensing component includes at least one of a physiological or environmental sensor component.

7. The system of claim 1, further comprising an annotation component that attaches a tag to a subset of the data wherein the tag facilitates queried retrieval of the subset of the data.

8. The system of claim 1, wherein the context includes at least two of activity context, user context or environment context.

9. The system of claim 8, wherein the activity context includes at least one of a current activity, a current state or current resource.

10. The system of claim 8, wherein the user context includes at least one of topic knowledge, state of mind or last location.

11. The system of claim 8, wherein the environment context includes at least one of physical conditions, social setting, people present, security rating, date/time, or location.

12. The system of claim 1, further comprising:
an experience analysis component that analyzes each of the plurality of experiences; and
an experience recorder component that captures the subset of data as a function of the analysis.

13. The system of claim 1, further comprising a rendering management component that facilitates presentation of the subset of data.

14. The system of claim 13, further comprising a content configuration component that synchronizes the subset of data based upon the at least two perceptions in view of a user preference.

15. The system of claim 14, further comprising a device configuration component that arranges the subset of data in accordance with display characteristics of a target device, wherein the subset of data is rendered via the target device as a function of the at least two perceptions.

16. The system of claim 1, further comprising a machine learning and reasoning component that employs at least one of a probabilistic and a statistical-based analysis that infers an action that a user desires to be automatically performed.

17. A computer-implemented method of capturing data associated to a real-world experience, comprising:
monitoring experiences based upon at least two perceptions in view of context;
capturing data associated to the at least two perceptions;
annotating the data based upon perception type; and
storing the annotated data.

18. The method of claim 17, wherein the at least two perceptions include at least two of vision, hearing, touch, smell, or taste.

19. The method of claim 17, further comprising:
generating a query;
employing the query to retrieve stored data as a function of the annotations;
synchronizing the retrieved data based upon context; and
rendering the synchronized data.

20. A computer-implemented system that facilitates capturing data, comprising:
means for monitoring data associated to at least two perceptions of a user, wherein the at least two perceptions include vision, hearing, touch, smell or taste;
means for capturing a subset of the data;
means for annotating the subset of the data;
means for synchronizing the annotated subset of the data; and
means for storing the synchronized annotated subset of the data.
